(19) United States
(12) Patent Application Publication
(10) Pub. No.: US 2019/0147531 A1
(43) Pub. Date: May 16, 2019

(54) CREDIT MANAGEMENT SYSTEM, METHOD, AND STORAGE MEDIUM

(71) Applicant: SUMITOMO MITSUI BANKING CORPORATION, Tokyo (JP)

(72) Inventors: Kiyonori UGAJIN, Tokyo (JP); Kazushige ONISHI, Tokyo (JP); Shinichiro NISHINO, Tokyo (JP); Takuya MIZUGUCHI, Tokyo (JP)

(21) Appl. No.: 15/748,933

(22) PCT Filed: Jul. 31, 2015
(86) PCT No.: PCT/JP2015/003890

§ 371 Date: Jan. 30, 2018

(51) Int. Cl. G06Q 40/02; G06Q 10/06

(52) U.S. Cl. CPC G06Q 40/025; G06Q 10/0635; G06Q 10/06315

(57) ABSTRACT

A credit management system includes a device configured to store customer information for each customer; a device configured to store deal information for each credit transaction, the deal information being associated with one or more customer information; a device configured to receive an identifier for specifying a customer or a credit transaction; and a device configured to notify deal information associated with a customer having the received identifier, or customer information associated with a credit transaction having the received identifier.

### TECHNICAL FIELD

The present invention relates to a credit management system, method, and program.

### BACKGROUND ART

Recently, in banks, there are increasing cases of financing using a technique referred to as structured finance. Representative examples of structured finance are project finance and LBO finance. In project finance, a bank finances an SPC (special purpose company) established for the purpose of conducting a business or a project. An SPC, which is a nominal company invested and established by a plurality of corporations (hereinafter, referred to as sponsors), is the borrower of the financing. In other words, the sponsor itself is not the borrower of the financing. However, occurrence of a change in the financial situation of the sponsor may largely affect the successor failure of the project. In addition, the financial situation of a corporation that purchases products or services produced by the project (hereinafter, referred to as off-taker) may also affect the success or failure of the project.

Therefore, a bank is required to evaluate the credit risk and judge the credit of not only the SPC, which is the borrower, but also the corporation which may affect the project such as the sponsor or the off-taker (hereinafter, referred to as related party). In other words, when the financial situation of a certain corporation has turned worse, the bank has to quickly grasp the project (i.e. financing in which the corporation is a related party) which may be affected due to the worsening.

Furthermore, as result of a project being adversely affected due to a certain related party, the effect may spread as far as other related parties of the project (for example, financial situation of other related parties, or other projects in which other related parties are involved may be affected). Therefore the bank is also required to grasp other related parties of the project. Similarly, when there is a possibility that a problem may occur in a project due to a certain reason such as natural disaster, economic situation of respective countries, or the like, the bank is required to quickly extract related parties of the project.

In addition, the financial situation of a corporation may vary in accordance with the financial situation of a subsidiary or an affiliate. In other words, worsening of the financial situation of a subsidiary or an affiliate may immediately lead to worsening of the financial situation of the parent company. Therefore, in a case where a subsidiary is a related party of a certain project, for example, the bank is required to grasp which of the corporations is the parent company when there is a possibility that a problem may occur in the project.

As thus described, credit uncertainty of a certain corporation or various events in the world may indirectly affect a large number of corporations or projects, and ultimately a large number of financing deals. However, the only measure taken so far has been such that bank employees of respective branches keep information relating to their customers and financing deals in respective forms. In the case of corporate finance that provides corporations with financing, a corporation which may be affected (i.e., borrowing corporation) may be easily detected. However, in the case of project finance, a related party is not the borrower and therefore it takes substantial time to extract a corporation (i.e., related party) or a project which may be affected. Accordingly, it has been difficult for a bank staff to quickly consider cancellation of financing even when an event that may affect the financing has occurred before conducting the financing. In addition, even when an event that may affect financing has occurred after having conducted the financing, it has been difficult for a bank staff to quickly consider debt collection.

### SUMMARY OF INVENTION

It is an object of the present invention to provide a system, a method, and a program which allows for associating customer information with deal information of financing so as to extract financing or a corporation which is directly or indirectly affected, when a change has occurred in the financial situation of a certain corporation or the progress of a project.

A first aspect of the present invention is a credit management system. The system includes a device configured to store customer information for each customer; a device configured to store deal information for each credit transaction, the deal information being associated with one or more customer information; a device configured to receive an identifier for specifying a customer or a credit transaction; and a device configured to notify deal information associated with a customer having the received identifier, or customer information associated with a credit transaction having the received identifier.

A second aspect of the present invention is a method performed by a credit management system. The credit management system stores customer information for each customer and deal information for each credit transaction, the deal information being associated with one or more customer information, and the method includes a step of receiving an identifier for specifying a customer or a credit transaction; and a step of notifying deal information associated with a customer having the received identifier, or customer information associated with a credit transaction having the received identifier.

A third aspect of the present invention is a credit management program. The program causes a computer to function as the credit management system of the first aspect.

### BRIEF DESCRIPTION OF DRAWINGS

Detailed understanding of embodiments disclosed in the present specification can be acquired from the following description illustrated with regard to the accompanying drawings.

FIG. 1 is a schematic drawing of the present invention;

FIG. 2A is a correlation diagram between respective pieces of information of the present invention;

FIG. 2B is a correlation diagram between respective pieces of information of the present invention;

FIG. 3 illustrates a bank system, a plurality of bank terminals, and a network communicably connecting the bank system and the plurality of bank terminals;

FIG. 4 is an explanatory diagram of a system configuration of a bank system;

FIG. 5 is a functional block diagram of a customer information management subsystem;

FIG. 6 is a functional block diagram of a deal information management subsystem;

FIG. 7 is a functional block diagram of a decision subsystem;

FIG. 8 illustrates a flow of an acquisition process of financial information or the like;

FIG. 9 illustrates a flow of an extraction process of deal information in which a particular customer is involved; and

FIG. 10 illustrates a flow of an extraction process of related party information and customer information of a particular deal.

### DESCRIPTION OF EMBODIMENTS

### Definition of Terms

Meaning of the following terms used in the present specification will be defined.

Overseas credit: Financing provided by an overseas branch of a bank or local subsidiary associated with the bank to a customer of the bank. There are “facility” and “exposure” as terms corresponding to credit. The former is used when referring to individual credit, and the latter is used when referring to the entire credit for a customer.

Overseas credit management: Management of the credit status of a borrowing corporation in the context of overseas credit.

Lending Office: A branch or local subsidiary taking responsibility of credit. In a case where a plurality of branches or local subsidiaries deals with a single customer, a Primary Lending Office (PLO) refers to an office which collectively manages customer information and performs borrower evaluation, and a Secondary Lending Office (SLO) refers to an office other than the Primary Lending Office.

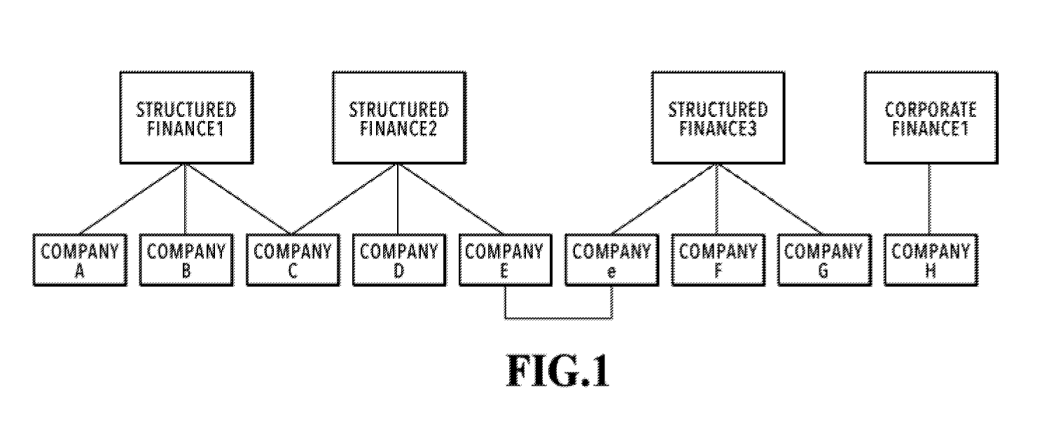

FIG. 1 is a schematic drawing of the present invention. As illustrated in FIG. 1, financing based on structured finances 1 to 3 is going to be conducted from now on, or has already been conducted. Companies A, B and C are related parties of the structured finance 1 (for example, project finance). In addition, companies C, D, and E are related parties of the structured finance 2 (for example, project finance). In addition, a company e (subsidiary or affiliate of company E), companies F and G are related parties of the structured finance 3 (for example, project finance).

According to the present invention, when the financial situation of the company C has turned worse, it is possible to extract the structured finances 1 and 2 which are affected due to the worsening (i.e., financing in which the company C is a related party). Furthermore, according to the present invention, it is possible to extract other related parties of the structured finances 1 and 2 (i.e., the companies A and B, and the companies D and E which are related parties other than the company C). Similarly, according to the present invention, when an event that affects respective structured finances has occurred, it is possible to extract the related parties of respective structured finances. In addition, when an event that affects structured finance 3 has occurred, it is possible to extract the company E which is the parent company of the company e which is a related party (also possible in a case where the parent company and the subsidiary or the like are reversed). Note that the present invention is not limited to structured finance and can also be applied to corporate finance. In other words, as illustrated in FIG. 1, the customer information of a company H is associated with the deal information of financing to the company H using the scheme of corporate finance.

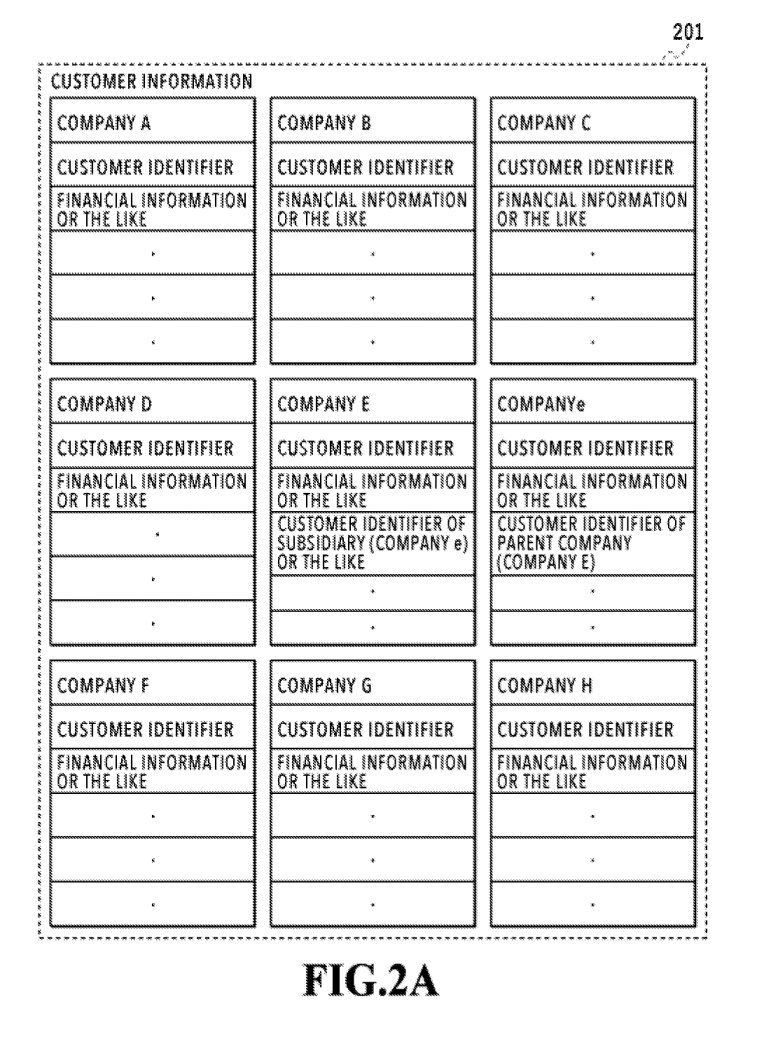

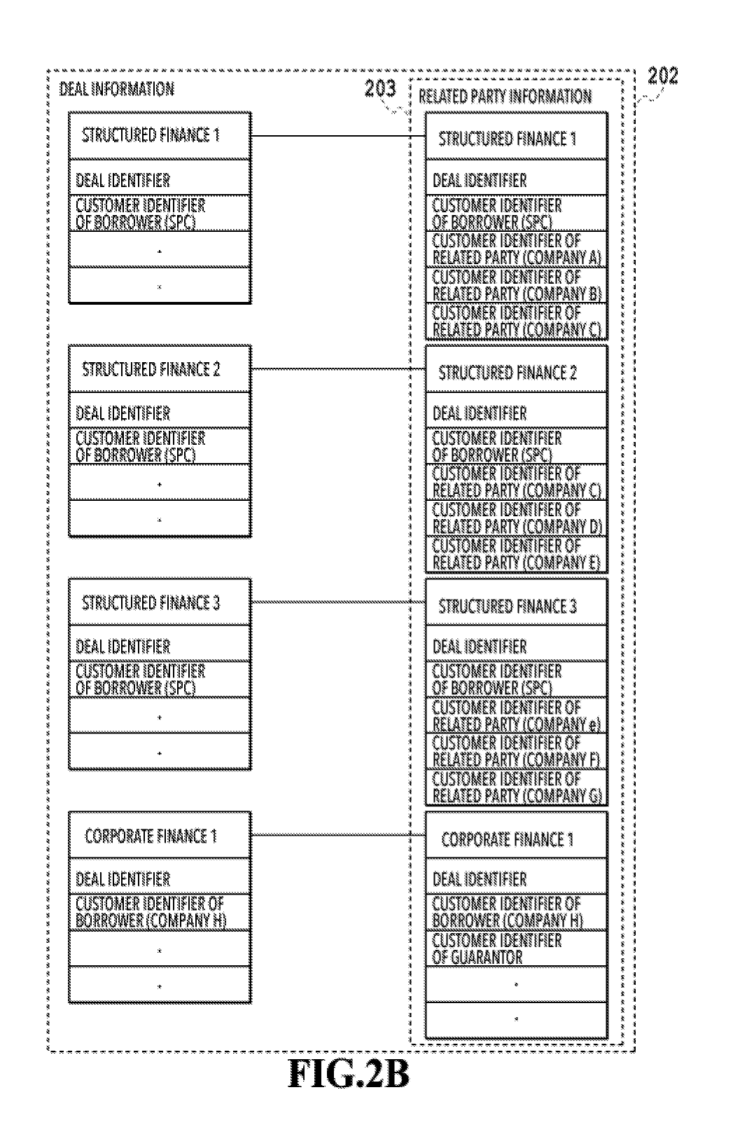

FIGS. 2A and 2B are correlation diagrams between respective pieces of information of the present invention. The present invention allows customer information 201, deal information 202, and related party information 203 to be managed in association with each other, as illustrated in FIGS. 2A and 2B. The customer information 201 can be information relating to customers of a bank including financial information and the like of the customers (in the case of FIG. 1, information relating to the companies A to H, and the company e). The customer information 201 may be created for each customer. Each of the customer information 201 may be provided with a customer identifier for identifying a customer. In addition, the customer information 201 can include information for identifying a parent company, a subsidiary, an affiliate, or the like, of the customer. For example, customer information of the company E includes information (customer identifier of the company e) for identifying the company e, which is a subsidiary, or the like. On the other hand, customer information of the company e includes information (customer identifier of the company E) for identifying the company E, which is the parent company.

The deal information 202 can be information relating to a credit transaction including details of the credit or a collateral (in the case of FIG. 1, information relating to financing using the scheme of structured finances 1 to 3, and corporate finance 1). The deal information 202 may be created for each unit of credit transaction (for each financing deal). In other words, when additional financing is conducted for a same business or project, a new deal information may be created. Each of deal information 202 may be provided with a deal identifier for identifying a deal. In addition, the deal information 202 can include information for identifying a borrower of the deal. For example, the deal information of the structured finances 1 to 3 includes information for identifying the borrower (customer identifier of SPC). On the other hand, the deal information of the corporate finance 1 includes a customer identifier of the company H, which is the borrower.

The related party information 203 can be information relating to related parties of project finances (in the case of FIG. 1, the companies A, B and C of the structured finance 1, the companies C, D and E of the structured finance 2, and the companies e, F and G of the structured finance 3). In the case of structured finances, the related party information 203 can include information for identifying related parties (customer identifiers of all related parties). Additionally, in the case of corporate finance, the related party information 203 can include information for identifying guarantors (customer identifiers of all guarantors). In addition, the related party information 203 can include information for identifying a borrower of the deal. In addition, each of the related party information 203 may be provided with a deal identifier of a corresponding deal.

As thus described, the present invention allows for managing information of not only borrowers but also corporations associated with the cash flow of the business or project in the case of project finance.

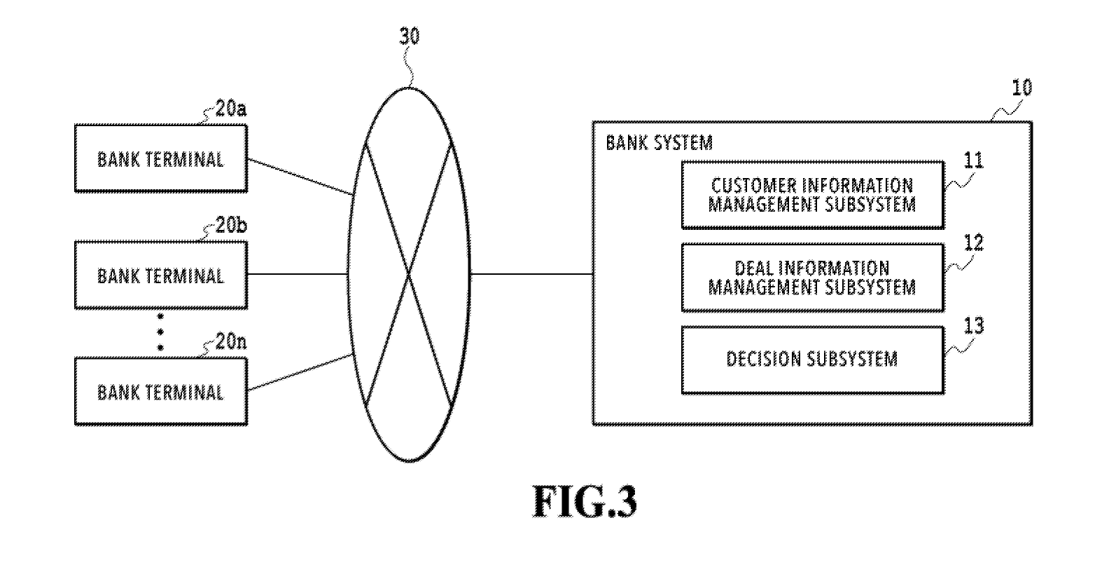

FIG. 3 illustrates a bank system 10 which may be used by a bank, a plurality of bank terminals 20, and an intra-bank network or the Internet 30 (referred to as “network 30” in the present specification) communicably connecting the bank system and a plurality of bank terminals 20a, 20b, . . . , 20n (collectively referred to as “bank terminal 20” in the present specification). The bank system 10 is a system capable of handling deposit affairs, loan affairs, domestic exchange affairs, foreign exchange affairs, and similar affairs. For the purpose of explanation, the present specification describes functions and processes relating to credit management that associates deal information with customer information, among the main functions of the bank system 10.

The bank terminal 20 is a terminal capable of accessing the bank system 10 via the network 30 to use the functions provided by the bank system 10. The bank terminal 20 may be any terminal available by a bank employee without being limited to any particular type. For example, the bank terminal 20 can include a personal computer (PC), a laptop, a tablet terminal, or any other type of device that is operable in a wired or wireless environment. The network 30 may be a known network that allows mutual communication including the Internet, a dedicated line, or the like, without being limited to any particular type.

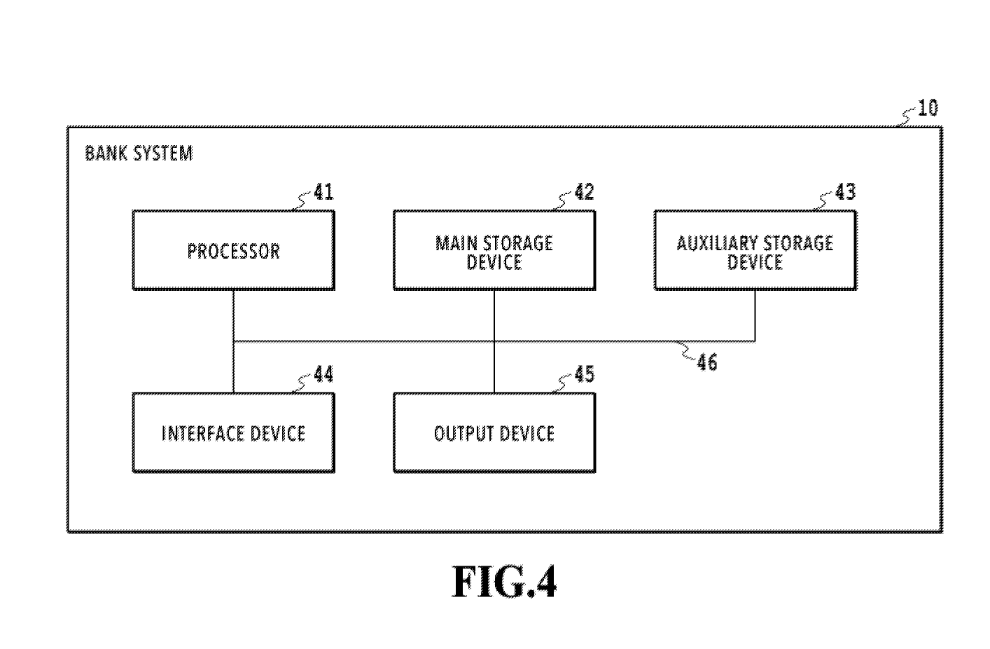

FIG. 4 is an explanatory diagram of a system configuration of the bank system 10. The bank system 10 can include a processor 41, a main storage device 42, an auxiliary storage device 43, an interface device 44, and an output device 45. The devices 41 to 45 can be connected to each other via bus 46 or the like.

The processor 41, which performs control of each component and data processing in the bank system 10, is capable of reading various programs stored in the auxiliary storage device 43 out to the main storage device 42 and executing the programs thereon. The main storage device 42 is capable of storing various transmission and reception data, computer-executable instructions, and data after processing by the instructions. The auxiliary storage device 43, which is a storage device such as an HDD (Hard Disk Drive) or an SSD (Solid State Drive), is capable of storing data and programs for a long time.

FIG. 4 illustrates an embodiment in which the processor 41, the main storage device 42, and the auxiliary storage device 43 are provided in a same computer. In another embodiment of the present invention, the bank system 10 can be configured to realize parallel distributed processing by a plurality of computers by using a plurality of the processors 41, the main storage devices 42, and the auxiliary storage devices 43. There can be another embodiment of the present invention in which a plurality of computers is provided for the bank system 10, the plurality of computers sharing the single auxiliary storage device 43.

The interface device 44 serves as an interface when transmitting and receiving data to and from other systems or devices. The interface device 44 can provide an interface for receiving various commands and input data (for example, data of various master files) from the system operator. The output device 45 is capable of displaying data processed by the processor 41 and/or data read-out from various databases or files. The output device 45 is capable of providing a function to print the data displayed on the display.

As illustrated in FIG. 3, the bank system 10 can include a customer information management subsystem 11, a deal information management subsystem 12, and a decision subsystem 13. The subsystems 11 to 13 can each include a processor, a main storage device, an auxiliary storage device, an interface device, and an output device which may be connected to each other via a bus or the like, and the devices can include functions similar to those of the devices 41 to 45.

The customer information management subsystem 11 is used for managing customer information used in a credit management process. The customer information used in the present invention is available not by each lending office but by a plurality of departments and lending offices in a bank, and is different from customer information in a conventional CIF (customer information file). The customer information in the CIF has been habitually created and maintained by each lending office. When a particular corporation makes the transaction with a plurality of lending offices in a bank, each lending office has been habitually creating and maintaining customer information and therefore no collective information management has been performed in the bank.

The deal information management subsystem 12 is used for managing deal information relating to financing. The deal information management subsystem 12 can handle deal information of both corporate finance and structured finance. The deal information can include factual information such as background and reason of funding needs of the corporation that is a customer, as well as use of funds and loan period.

The decision subsystem 13 is a system for creating a credit application for an overseas credit, circulating it around related departments, and acquiring approval from a decision-making authority. The decision subsystem 13 can hold customer information and deal information at the time point of examining the content of the credit application. The customer information and the deal information to be held can be as of when starting creation of and/or deciding the credit application.

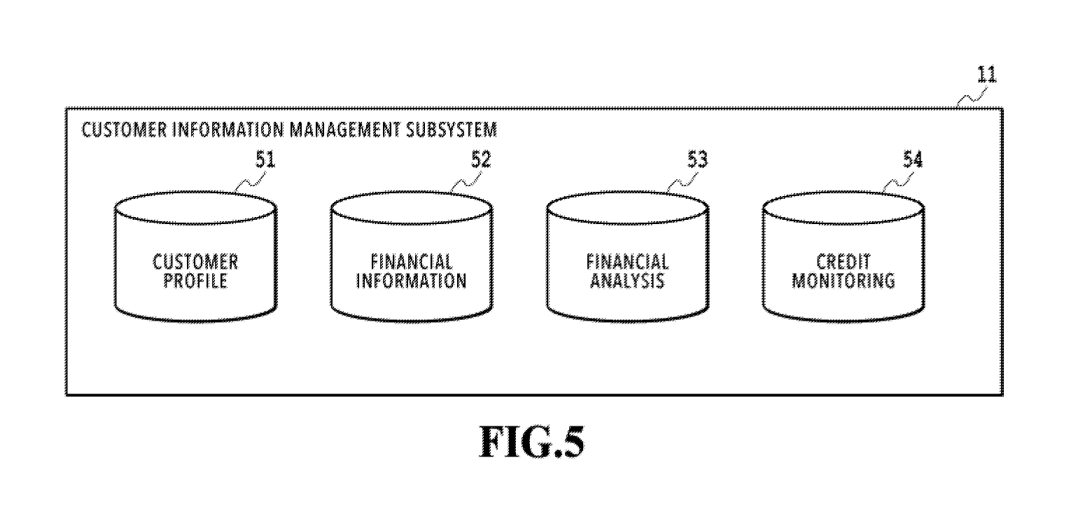

FIG. 5 is a functional block diagram of the customer information management subsystem 11. The customer information management subsystem 11 can include customer profile 51, financial information 52, financial analysis 53, and credit monitoring 54. The elements 51 to 54 are data shared in the bank system 10, and are collectively referred to as “customer information”. The elements 51 to 54 are associated with each other by a customer identifier. The customer information is different from the conventional CIF since it can be shared by a plurality of departments and lending offices.

The customer profile 51 can include profile information such as, for example, customer identifier, group structure (customer identifiers of the parent company, subsidiaries, and affiliates), company name, location of head quarter, year established, number of employees, locations (names of countries and cities) of plants and/or branches, stock information, shareholders, history of management, relation with banks, key persons, business divisions, regional segments, main customers, main suppliers, or the like.

The financial information 52 can include a profit and loss statement, a balance sheet, and a cash flow statement of a customer, as well as source data of each piece of financial information. The financial information 52 can include data over a plurality of calendar years. The financial information 52 can include actual and projected data. The content of the financial information 52 can be information acquired from a rating company.

The financial analysis 53 can include an analytical result based on information stored in the financial information 52. The financial analysis is performed by a bank staff, and the analytical result thereof can be used for credit decision.

The credit monitoring 54 can include monitoring information such as credit rating of borrower, status of borrower (good, caution needed, etc.), grade of borrower (high, medium, low, etc.). The content of the monitoring information can be decided on the basis of a criterion defined by a bank, and/or can be information acquired from a rating company.

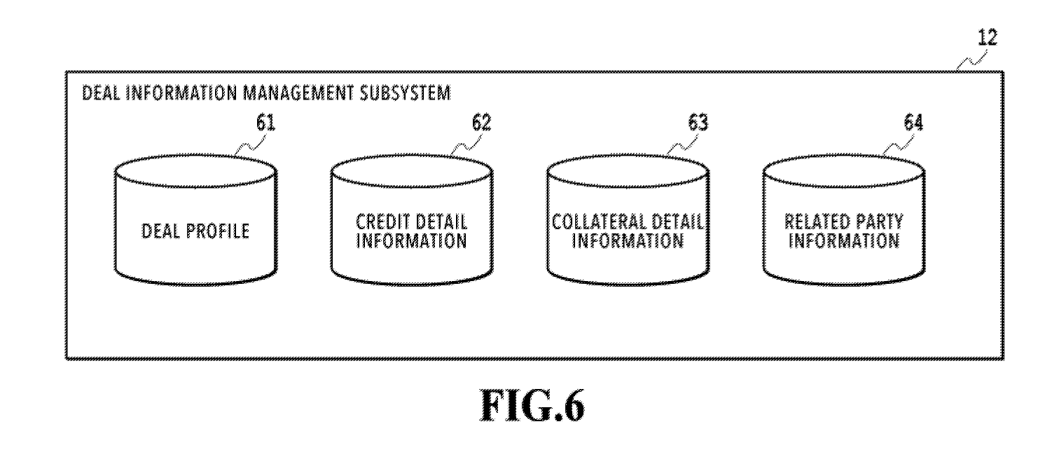

FIG. 6 is a functional block diagram of the deal information management subsystem 12. The deal information management subsystem 12 is capable of handling deal information for each unit (each financing deal) of credit transaction. The deal information management subsystem 12 can include deal profile 61, credit detail information 62, collateral detail information 63, and related party information 64. The elements 61 to 64 are collectively referred to as “deal information”. The deal information management subsystem 12, unlike the conventional bank system, is capable of handling transactions in which a plurality of lending offices is involved, and/or transactions in which a plurality of borrowers is involved.

The deal profile 61 can have stored therein a profile of a deal. The information stored in the deal profile 61 can be associated with the information stored in the credit detail information 62 and the collateral detail information 63 by using the deal identifier.

The deal profile 61 can include basic information (deal identifier, one or more borrowers, deal information name, deal information owner, one or more lending offices), deal information summary, deal information background, lending structure, and support sharing.

The basic information can include a deal identifier for identifying deal information, customers identifiers of one or more borrowers, a name indicating the deal information, and one or more lending offices. The deal information summary can include a summary of a transaction. For example, the deal information summary can include information such as “the purpose of financing is to provide operating funds to a business company whose head quarter is located in India. The lending period is one year and the loan amount is ten million dollars. The lending offices in New Delhi (NDL) and Singapore (SNG) conduct financing with five million dollars each”. The deal information background can include background circumstances and reason for conducting the financing. The lending structure can include an explanatory diagram of the scheme of financing and an explanatory text thereof. The support sharing can indicate support proportions of respective financial institutions (for example, 40% for Bank A, 35% for Bank B, and 25% for Bank C) in a case where a plurality of financial institutions conducts financing.

The credit detail information 62 can include detail information of financing such as detail number, borrower, type of credit, currency, and amount of money lent. The collateral detail information 63 can include detail information of the collateral of the deal information. In a case where a plurality of lending offices is involved in the deal information, the credit detail information 62 can indicate a total extreme amount resulted from summing up the extreme amounts which have been set in respective lending offices. The credit detail information 62 and the collateral detail information 63 can include information of a plurality of borrowers.

The related party information 64 can include a deal identifier of a corresponding deal, customer identifiers of one or more related parties, an asset profile (project summary, structure, milestone, etc.), a contract document number, financial information, a customer identifier of a borrower. The related party information 64 can have stored therein information for identifying sponsors, off-takers, or the like (customer identifiers of all the sponsors or off-takers) in a case where the type of financing is structured finance (for example, financing to a special purpose company (SPC) for a certain project). In addition, the related party information 64 can have stored therein information for identifying the guarantor (customer identifiers of all the guarantors) in a case where the type of financing is corporate finance.

The asset profile can include information such as summary of project, scheme (structure), and schedule and milestone. The contract document number indicates identification information of a contract document associated with structured finance. The financial information indicates financial information of a project (profit and loss statement, balance sheet, cash flow statement or the like).

The related party information 64 can include roles in a project. For example, the roles may include borrower, guarantor, sponsor, underlying asset owner, buyer, seller, or the like. In structured finance in which a plurality of related parties can be involved, the related party information 64 can be maintained by, for example, a lending office being in charge of SPC. Using the related party information 64, one or more related parties involved in a project can be identified. Accordingly, it becomes possible to identify a customer supposed to be affected in the event of an occurrence of loss in a project.

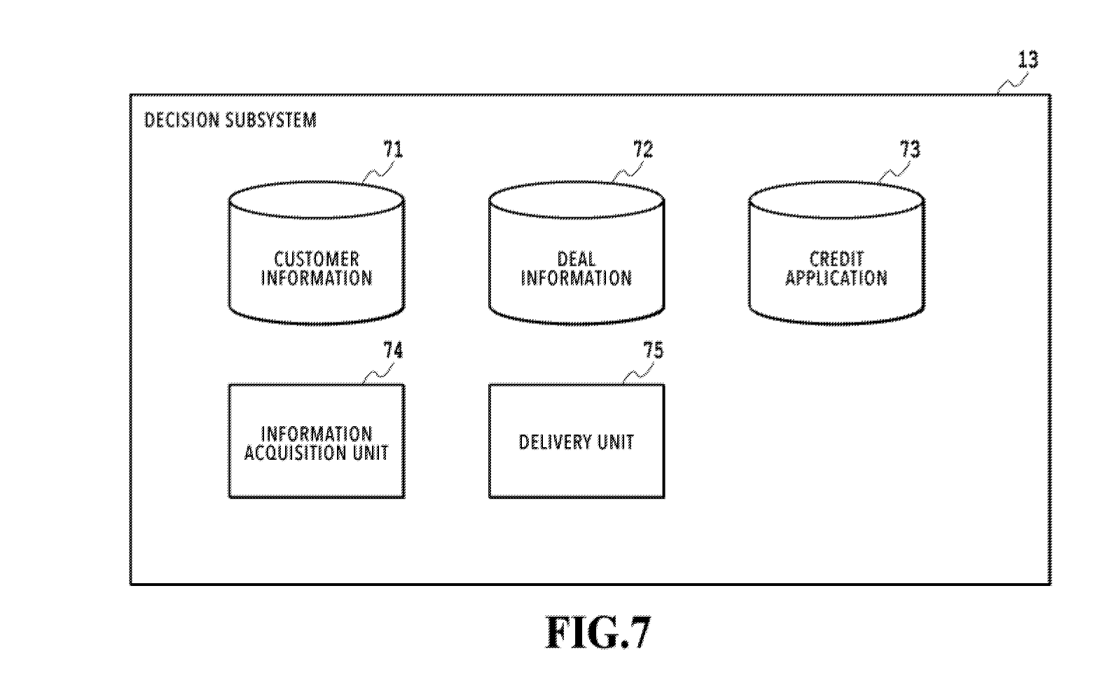

FIG. 7 is a functional block diagram of the decision subsystem 13. The decision subsystem 13 can include, as databases or files, customer information 71, deal information 72, and credit application 73. The decision subsystem 13 can include an information acquisition unit 74 and a delivery unit 75 as processing components.

The customer information 71 can have stored therein a copy of customer information as of when a credit application is drafted, and as of when the credit application is decided. The deal information 72 can have stored therein a copy of deal information as of when a credit application is drafted, and as of when the credit application is decided. The deal information 72 can include status information, the status information indicating “Pending” before a credit application is decided, and indicating “Fixed” after the decision.

The credit application 73 can have stored therein data of a credit application. The credit application can include a credit application identifier and a status. The credit application identifier indicates an identifier of a credit application, and the status indicates a situation of examination (for example, “before decision”, and “decided”). A credit application can be associated with the customer information 71 and the deal information 72. For example, the credit application can include a credit application identifier, and an identifier of the customer information 71 and an identifier of the deal information 72 associated with the credit application identifier, and therefore it is possible to associate the credit application with the customer information 71 and the deal information 72.

The information acquisition unit 74 can acquire “customer information” and “deal information” as of when a credit application is drafted and as of when the credit application is decided from the customer information management subsystem 11 and the deal information management subsystem 12. The delivery unit 75 is capable of notifying a confirming person and a person with authority selected by a drafter of a credit application of the fact that there exists a credit application to be confirmed. The confirming person and the person with authority who have been notified refer to the content of the credit application stored in the credit application 73, and register approval or refusal.

As thus described, in the present invention, a credit application has associated therein customer information and deal information. Therefore, in a case where the financial situation of a customer has worsened or a project received an adverse effect while a credit application is being circulated, a bank staff can extract, and cancel the circulation of, the credit application of the financing in order to cancel the financing.

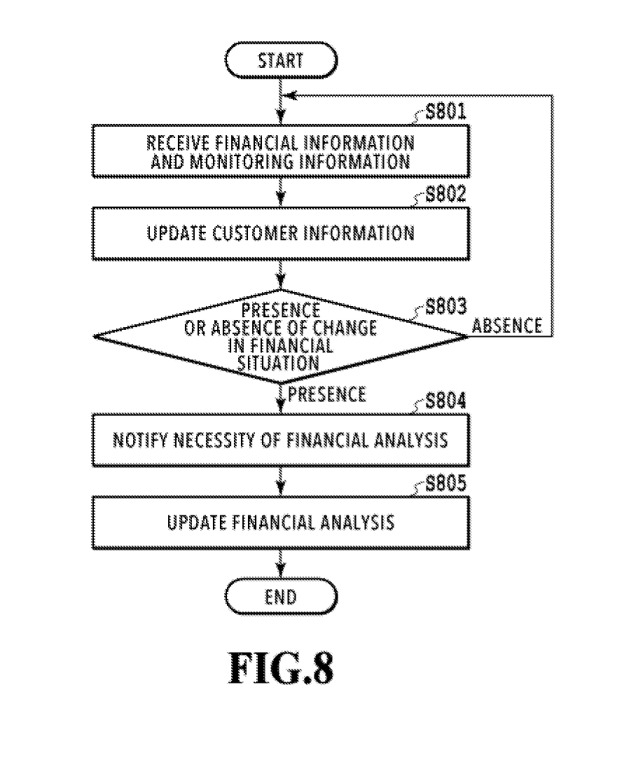

FIG. 8 illustrates a flow of an acquisition process of financial information or the like. In other words, the bank system 10 is capable of automatically acquiring financial information and monitoring information of a customer from a system of an external rating company, and updating the data of the financial information 52 and the credit monitoring 54 in the customer information.

At step 801, the bank system 10 can receive financial information and monitoring information of a customer from the system of the external rating company.

At step 802, the bank system 10 can update the data of the financial information 52 and the credit monitoring 54 in the customer information, by using the information received at step 801.

At step 803, the bank system 10 can judge whether or not there is a change in the financial situation of the customer due to the updating at step 802. For example, the bank system 10 can judge that there is a change in the financial situation of a customer in a case where a predetermined condition is satisfied. For example, the predetermined condition is variation of rating in the credit monitoring 54. Alternatively, for example, the predetermined condition is variation of the rating of the parent company, worsening of industry trend, surfacing of country risk, or the like. The condition is supposed to be different depending on the type of industry or the type of operation of the customer. In a case where there is a change in the financial situation, the process flow proceeds to step 804, whereas the process flow returns to step 801, in a case where there is no change in the financial situation.

At step 804, the bank system 10 can notify the bank terminal 20 of the necessity of reviewing the financial analysis 53 in the customer information. Therefore, the bank staff can know that it is necessary to review the financial analysis (i.e., review of credit decision).

At step 805, the bank system 10 can receive data of anew financial analysis 53 from the bank terminal 20. In other words, the bank staff reviews the financial analysis. As a result, the data which has been input to the bank terminal 20 is transmitted to the bank system 10. The bank system 10 can update the financial analysis 53 by using the received data.

In addition, in a case where it is judged at step 803 that there is a change in the financial situation, the bank system 10 can notify the bank terminal 20 of the possibility that the customer may no longer be functioning as a related party. Specifically, the bank system 10 can also specify the customer identifier of a customer whose financial situation is judged at step 803 to have changed (i.e., a customer identifier associated with the financial information 52 and/or the credit monitoring 54 which has changed is specified). Next, the bank system 10 can extract, from the related party information 64, a related party having the specified customer identifier. Next, the bank system 10 can specify all the deal information associated with the extracted related party and the customer information of the extracted related party. Next, the bank system 10 can notify the customer information of the customer, together with the deal information of the financing in which the customer is involved as a related party (i.e., the specified deal information and customer information are transmitted to the bank terminal 20). For example, the notification can be performed by displaying a warning on a display screen of customer information and deal information on the bank terminal 20. Therefore, the bank staff can know that it is necessary to pay attention to a related party of a deal of which the bank staff is in charge.

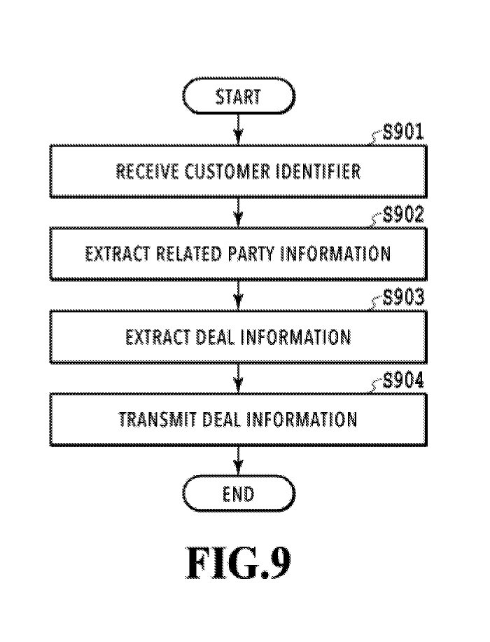

FIG. 9 illustrates a flow of an extraction process of deal information in which a particular customer is involved.

At step 901, the bank system 10 can receive a customer identifier from the bank terminal 20. The customer identifier is an identifier for specifying a customer included in the customer profile 51 of the customer information, deal profile 61 of the deal information, and the related party information 64. For example, the bank staff inputs, to the bank terminal 20, a customer identifier provided to a corporation in order to extract the deal information in which the corporation is involved which has received an adverse effect due to a natural disaster, the economic situation of respective countries or the like. A deal information in which the corporation having the customer identifier is involved is supposed to be extracted.

At step 902, the bank system 10 can extract, from the related party information 64, a related party having the customer identifier received at step 901. Specifically, the bank system 10 can judge whether or not the related party having the customer identifier received at step 901 is included in the related party information 64. When included, the process flow proceeds to step 903. When not included, the bank system 10 can notify the bank terminal 20 of the fact that there is no deal information in which the customer is involved.

At step 903, the bank system 10 can extract the deal information corresponding to the related party extracted at step 902. Specifically, the bank system 10 can extract the deal information associated with the related party information including the related party extracted at step 902 (i.e., at least one of the deal profile 61, the credit detail information 62, the collateral detail information 63, and the related party information 64).

At step 904, the bank system 10 can transmit the deal information extracted at step 903 to the bank terminal 20.

As thus described, the bank staff can extract the deal information in which a particular customer is involved. Therefore, when, for example, the status information of the deal information 72 of the decision subsystem 13 of the deal is “Pending (i.e., before the credit application is decided)”, the staff can quickly consider cancellation of the financing. Alternatively, when the status information of the deal information 72 of the decision subsystem 13 of the deal is “Fixed (i.e., after the credit application has been decided)”, the staff can quickly consider debt collection. Furthermore, the staff can perform symptom management for a deal being already handled regardless of whether or not a credit application has been circulated.

Moreover, at step 904, the bank system 10 can also transmit information of other related parties of the deal information extracted at step 903 (i.e., related parties other than the related party extracted at step 902). Specifically, the bank system 10 can specify customer identifiers of other related parties in related party information having the deal identifier of the deal information extracted at step 903. Next, the bank system 10 can extract and transmit the customer information having the specified customer identifier (i.e., at least one of the customer profile 51, the financial information 52, the financial analysis 53, and the credit monitoring 54). As thus described, the present invention allows for extracting not only information of a deal in which a certain customer is involved, but also other customers involved in the deal. Note that the bank system 10 can also transmit customer information of parent companies, subsidiaries, and affiliates of the other related parties extracted at step 904 (i.e., at least one of the customer profile 51, the financial information 52, the financial analysis 53, and the credit monitoring 54).

Note that step 902 can be omitted in the case of corporate finance. In other words, the bank system 10 can extract, at step 903, deal information in which the customer having the customer identifier received at step 901 is a borrower. Next, the bank system 10 can transmit the extracted deal information to the bank terminal 20.

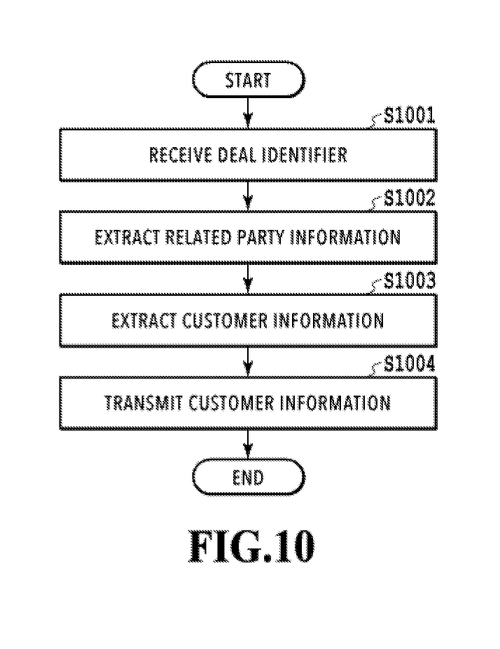

FIG. 10 illustrates the flow of the extraction process of related party information and customer information of a particular deal.

At step 1001, the bank system 10 can receive a deal identifier from the bank terminal 20. The deal identifier is an identifier for specifying a deal included in the deal profile 61 of the deal information and the related party information 64. For example, in order to extract corporations that are affected by worsening of a certain project, the bank staff inputs, to the bank terminal 20, the deal identifier provided to the project finance. It turns out that corporations involved in the project finance having the deal identifier are extracted.

At step 1002, the bank system 10 can extract, from the related party information 64, related parties of the deal having the deal identifier received at step 1001. Specifically, the bank system 10 can extract, from the deal profile 61 of the deal information, the deal information having the deal identifier received at step 1001. Next, the bank system 10 can extract all the related parties included in the related party information associated with the extracted deal information.

At step 1003, the bank system 10 can extract the customer information of all the related parties extracted at step 1002 (i.e., at least one of the customer profile 51, the financial information 52, the financial analysis 53, and the credit monitoring 54).

At step 1004, the bank system 10 can transmit the customer information extracted at step 1003 to the bank terminal 20.

Moreover, at step 1004, the bank system 10 can also transmit customer information of parent companies, subsidiaries, and affiliates of the customers extracted at step 1003 (i.e., at least one of the customer profile 51, the financial information 52, the financial analysis 53, and the credit monitoring 54). Specifically, the bank system 10 can specify customer identifiers of parent companies, subsidiaries, affiliates, or the like, included in the customer information of the customers. Next, the bank system 10 can extract the customer information having the specified customer identifier. Next, the bank system 10 can transmit the extracted customer information of parent companies, subsidiaries, and affiliates.

As thus described, the bank staff can extract the related party information and the customer information of a particular deal. Therefore, for example, the staff can consider reviewing of the financial analysis 53 of the customer (i.e., reviewing of credit decision). In addition, for example, the staff can also extract other deals in which the customer is involved (i.e., other financing in which the customer is the related party), and consider the validity of financing of the deal or debt collection.

Note that, in the case of corporate finance, step 1002 can be omitted. In other words, the bank system 10 can extract, at step 1003, the borrower of the deal having the deal identifier received at step 1001. Next, the bank system. 10 can extract the customer information of the extracted borrower. Next, the bank system 10 can transmit the extracted customer information to the bank terminal 20.

Although the principle of the present invention has been described above, referring to exemplary embodiments, a person skilled in the art will understand that various embodiments with modified configurations and details can be realized without deviating from the gist of the present invention. Although, embodiments in which the bank system 10 includes the subsystems 11 to 13 have been described in the present specification, the present invention can be applied to other embodiments. For example, in a case where the bank system has the functions of the subsystems 11 to 13 and databases/files, the subsystems 11 to 13 need not to be used.

The present invention can take the form of embodiments such as, for example, a system, a device, a method, a program or a storage medium.

1. A credit management system comprising:
a device configured to store customer information for each customer, wherein the customers include at least one of borrower, related party, and guarantor;
a device configured to store deal information for each credit transaction, the deal information being associated with customer information of a plurality of customers;
a device configured to receive an identifier for specifying a customer or a credit transaction; and
a device configured to notify deal information associated with a customer having the received identifier, or customer information associated with a credit transaction having the received identifier.

2. The system according to claim 1, further comprising a device configured to notify, when the customer information is updated, the updated customer information and deal information associated with the updated customer information.

3. The system according to claim 1, wherein customer information of a plurality of customers associated with the deal information is related party information of project finance.

4. The system according to claim 1, wherein
the customer information includes information of a corporation related to the customer, and
the system further includes a device configured to notify customer information of the related corporation.

5. The system according to claim 1, further comprising a device configured to associate the customer information and the deal information with a credit application.

6. A method performed by a credit management system, the credit management system storing customer information for each customer and deal information for each credit transaction, wherein the customers include at least one of borrower, related party, and guarantor, the deal information being associated with customer information of a plurality of customers, the method comprising the steps of:
receiving an identifier for specifying a customer or a credit transaction; and
notifying deal information associated with a customer having the received identifier, or customer information associated with a credit transaction having the received identifier.

7. The method according to claim 6, further comprising the step of notifying, when the customer information is updated, the updated customer information and deal information associated with the updated customer information.

8. The method according to claim 6, wherein customer information of a plurality of customers associated with the deal information is related party information of project finance.

9. The method according to claim 6, wherein
the customer information includes information of a corporation related to the customer, and
the method further includes a step of notifying customer information of the related corporation.

10. The method according to claim 6, further comprising a step of associating the customer information and the deal information with a credit application.

11. A non-transitory computer readable storage medium storing a program for allowing a computer to execute a method, the computer storing customer information for each customer and deal information for each credit transaction, wherein the customers include at least one of borrower, related party, and guarantor, the deal information being associated with customer information of a plurality of customers, the method comprising:
receiving an identifier for specifying a customer or a credit transaction, and
notifying deal information associated with a customer having the received identifier, or customer information associated with a credit transaction having the received identifier.
